(19) United States
(12) Patent Application Publication
(10) Pub. No.: US 2013/0257838 A1
(43) Pub. Date: Oct. 3, 2013

(54) Circuit for Compensating Feed-Through Voltage, LCD Device, and Method for Compensating Feed-Through Voltage

(71) Applicants: Chiachiang Lin, Shenzhen (CN); Hunglung Hou, Shenzhen (CN)

(72) Inventors: Chiachiang Lin, Shenzhen (CN); Hunglung Hou, Shenzhen (CN)

(21) Appl. No.: 13/510,639

(22) PCT Filed: Apr. 24, 2012
(86) PCT No.: PCT/CN2012/074583

§ 371 Date: May 18, 2012

(30) Foreign Application Priority Data
Mar. 29, 2012 (CN) 201210087540.9

(51) Int. Cl. G09G 5/00; G09G 3/36

(52) U.S. Cl. 345/212; 345/92

(57) ABSTRACT

The invention provides a circuit for compensating feed-through voltage, a LCD device including the circuit, and a method for compensating feed-through voltage. The circuit for compensating feed-through voltage of a LCD device includes a common line(s) and a storage capacitor(s); one end of the storage capacitor is connected to a drain electrode of a TFT corresponding to liquid crystal molecules, the other end of the storage capacitor is connected to the common line, and the common line is connected with a transfer switch. The transfer switch includes two input ends; one input end of the transfer switch is connected to the high-level reference voltage, and the other input end of the transfer switch is connected to the low-level compensating voltage. In the invention, the transfer switch is used to switch the common line, the common line is switched to the low-level signal of the compensating voltage when the gate electrode voltage of the TFT is at the high level, and the common line is switched to the high-level signal of the reference voltage when the TFT gate electrode voltage is at low level. Thus, when the TFT is closed, a voltage rise is provided to the common line to increase the voltages at both ends of the pixel connected to the drain electrode of the TFT corresponding to the liquid crystal molecules to compensate the pressure drop caused by the feed-through voltage.

### TECHNICAL FIELD

The invention relates to the field of liquid crystal displays (LCDs), and more particularly to a circuit for compensating feed-through voltage, a LCD device, and a method for compensating feed-through voltage.

### BACKGROUND

Conventional LCD devices generally employ a thin-film transistor (TFT) to control the pixel display.

As shown in FIG. 1, a gate electrode of a TFT is connected with a scan line, a source electrode is connected with a data line, and a drain electrode is connected with a pixel electrode. A pixel capacitor C (LC) is formed between the pixel electrode and a color film (CF) substrate (CF-Vcom), and the pixel capacitor is in parallel connection with a compensating capacitor C (st). One end of the C (st) is connected with the drain electrode of the TFT, and the other end of the C (st) is connected with a common line Vcom. Because a parasitic capacitance C (gs) is generated between the gate electrode and the drain electrode of the TFT, the voltage drop of the end of the C (gs) connected with the gate electrode causes voltages at both ends of the pixel to decrease when the TFT is instantaneously closed, thereby generating feed-through voltages, and causing the display brightness to decrease. Under the condition that a display screen only has one Vcom, different feed-through voltages cause different brightness in different positions of the display screen. As shown in FIG. 2, for a LCD device driven from double sides, the images of the left and right sides of the display screen are bright when the display screen is in the condition of low gray-scale images.

CN Pat. Pub. No. CN100460939C, published on Feb. 11, 2009, discloses a LCD device and a pulse-wave adjusting circuit thereof. The LCD device includes a power source, a pulse-wave adjusting circuit, and a gate electrode drive chip. The pulse-wave adjusting circuit is connected between the power source and the gate electrode drive chip, and the power source is used for providing a power source signal. The pulse-wave adjusting circuit is used for adjusting a plurality of pulse waves of the power source signal or selecting an appropriate voltage level, to enable the wave shape of the pulse waves to have a cutting angle or increase the amplitude of the pulse waves. Thus, the influence of the feed-through voltage on the TFT in a drive circuit is compromised, and then the display quality of the LCD is improved.

CN Pat. Pub. No. CN1987620B, published on May 12, 2010, discloses a LCD device. Each pixel unit of the LCD device includes a TFT, a common electrode, and a pixel electrode. The pixel electrode and the common electrode form an LC capacitor. The TFT includes a gate electrode, a source electrode, and a drain electrode connected to the pixel electrode. A voltage compensating unit including a comparator is connected to the aforementioned circuit. When a voltage arrives at the LC capacitor, the comparator compares the potential of the source electrode of the TFT from opening time to closing time with the potential of the drain electrode after the TFT is closed, and outputs a voltage compensating signal to compensate the feed-through voltage of the TFT.

CN Pat. Pub. No. CN102023423A, published on Apr. 20, 2011, discloses a LCD device and a manufacturing method thereof. The LCD device includes a TFT-LCD array substrate and a CF substrate which are oppositely integrated and between which liquid crystal molecules are arranged. The TFT-LCD array substrate includes a gate line, a first TFT which is used for controlling a first data line to provide data voltage to the pixel electrode, and a second TFT which is used for controlling a second data line to provide common voltage to a storage electrode line. The CF substrate includes mutually independent common electrodes, and the common electrodes are electrically connected with the storage electrode line. In the invention, the voltage difference between the pixel electrode and the common electrode(s) is kept constant by arranging the mutually independent common electrodes on the CF substrate and arranging the TFT for controlling the common electrodes on the array substrate. Therefore, the display gray-scale difference of all the pixels because of different feed-through effects of all the pixels is eliminated, and the display quality is improved.

### SUMMARY

In view of the above-described problems, the aim of the invention is to provide a circuit for compensating feed-through voltage capable of compensating feed-through voltage, a LCD device comprising the circuit, and a method for compensating feed-through voltage.

The aim of the invention is achieved by the following technical scheme.

A circuit for compensating feed-through voltage of a LCD device comprises a common line(s) and a storage capacitor(s). One end of the storage capacitor is connected to a drain electrode of a TFT corresponding to liquid crystal molecules, the other end of the storage capacitor is connected to the common line, and the common line is connected with a transfer switch. The transfer switch comprises two input ends; one input end of the transfer switch is connected to a high-level reference voltage, and the other input end of the transfer switch is connected to a low-level compensating voltage.

Preferably, the number of the common line(s) is at least two. Each common line is connected with a group of the storage capacitor, and each common line corresponds to a transfer switch. The parameters of pixels in different positions are different, and each common line controls a group of display pixels. Different compensating voltages are set according to the parameter difference. Thus, the control accuracy is increased, and the display quality is further improved.

Preferably, the transfer switch comprises a first TFT and a second TFT. A source electrode of the first TFT is connected to the reference voltage, and a source electrode of the second TFT is connected to the compensating voltage. Both the drain electrodes of the two TFTs are connected to the same common line. A gate electrode of the first TFT is connected to the reference voltage, and a gate electrode of the second TFT is connected to a corresponding scan line of the LCD device. Because conventional LCD panels generally employ TFTs to control the pixel display, TFTs are used as transfer switches. The transfer switches can be simultaneously formed in the process of manufacturing the TFTs, favoring reduction of manufacturing cost.

Preferably, both the first TFT and the second TFT are N-type metal oxide semiconductor (MOS) transistors.

Preferably, the transfer switch comprises a first TFT and a second TFT. A source electrode of the first TFT is connected to the reference voltage, and a source electrode of the second TFT is connected to the compensating voltage. Both the drain electrodes of the two TFTs are connected to the same common line. Gate electrodes of the first and second TFT are connected to the same corresponding scan line of the LCD device. This is another specific control mode.

Preferably, the first TFT is a P-type MOS transistor, and the second TFT is an N-type MOS transistor.

Preferably, the number of the common line(s) is at least two. Each common line is connected with a group of the storage capacitor, and each common line corresponds to a transfer switch. The transfer switch comprises a first TFT and a second TFT. A source electrode of the first TFT is connected to the reference voltage, and a gate electrode of the first TFT is connected to the reference voltage. A source electrode of the second TFT is connected to the compensating voltage, and a gate electrode of the second TFT is connected to a corresponding scan line of the LCD device. Both the drain electrodes of the two TFTs are connected to the same common line, and both the first TFT and the second TFT are N-type MOS transistors.

Preferably, the number of the common line(s) is at least two. Each common line is connected with a group of the storage capacitor, and each common line corresponds to a transfer switch. The transfer switch comprises a first TFT and a second TFT. A source electrode of the first TFT is connected to the reference voltage; a source electrode of the second TFT is connected to the compensating voltage. Both the gate electrodes of the first TFT and the second TFT are connected to the same corresponding scan line of the LCD device, and both the drain electrodes are connected to the same common line. The first TFT is a P-type MOS transistor, and the second TFT is an N-type MOS transistor.

A LCD device comprises the circuit for compensating feed-through voltage of a LCD device mentioned above.

A method for compensating feed-through voltage of a LCD device comprises the following steps: switching a corresponding common line to a low-level compensating voltage by a transfer switch when a current scan line is being driven; and switching the common line to a high-level reference voltage when the drive of the scan line is removed.

In the invention, the transfer switch is used to switch the common line, the common line is switched to the low-level signal of the compensating voltage when the gate electrode voltage of the TFT is at the high level, and the common line is switched to the high-level signal of the reference voltage when the TFT gate electrode voltage is at low level. Thus, when the TFT is closed, a voltage rise is provided to the common line to increase the voltages at both ends of the pixel, thereby improving the display brightness.

### BRIEF DESCRIPTION OF FIGURES

FIG. 1 is a schematic diagram of a drive circuit of a convention LCD device;

FIG. 2 is a schematic diagram of aberrance of a gate electrode voltage of a conventional LCD device;

FIG. 3 is a schematic diagram of the invention;

FIG. 4 is a schematic diagram of a first example of the invention;

FIG. 5 is a schematic diagram of a second example of the invention; and

FIG. 6 is a schematic diagram of a driving principle of the invention.

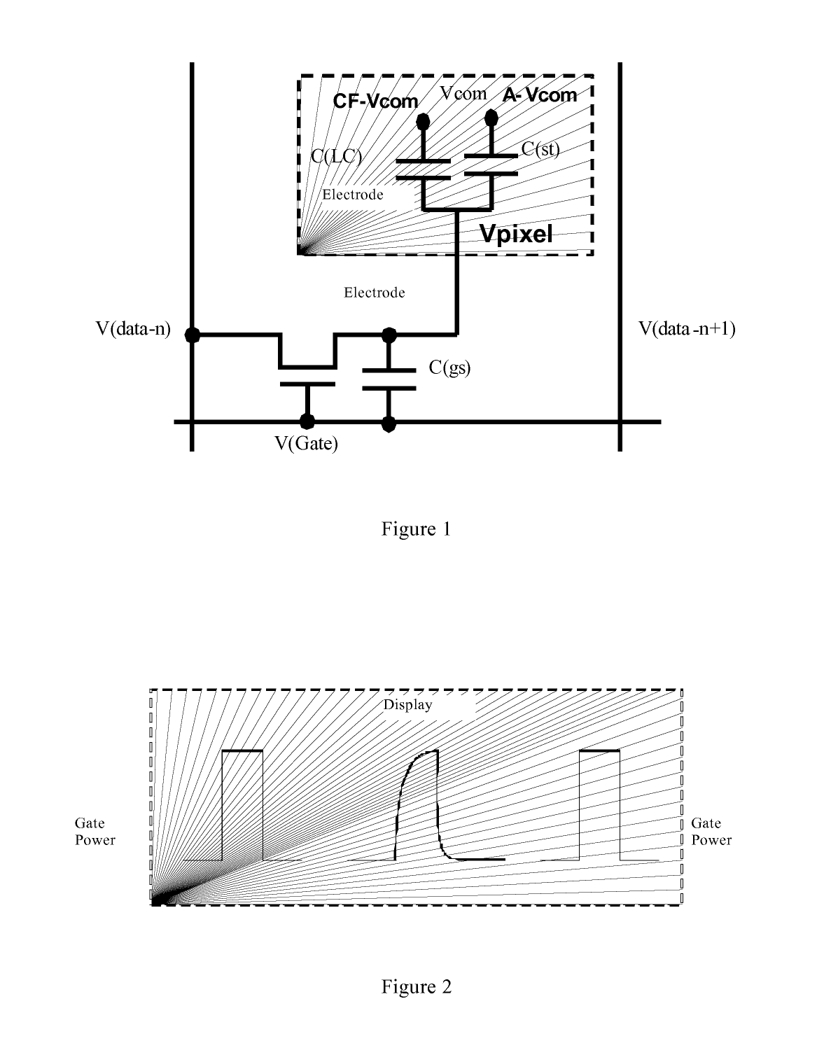

### DETAILED DESCRIPTION

The invention will further be described in detail in accordance with the figures and the preferable examples.

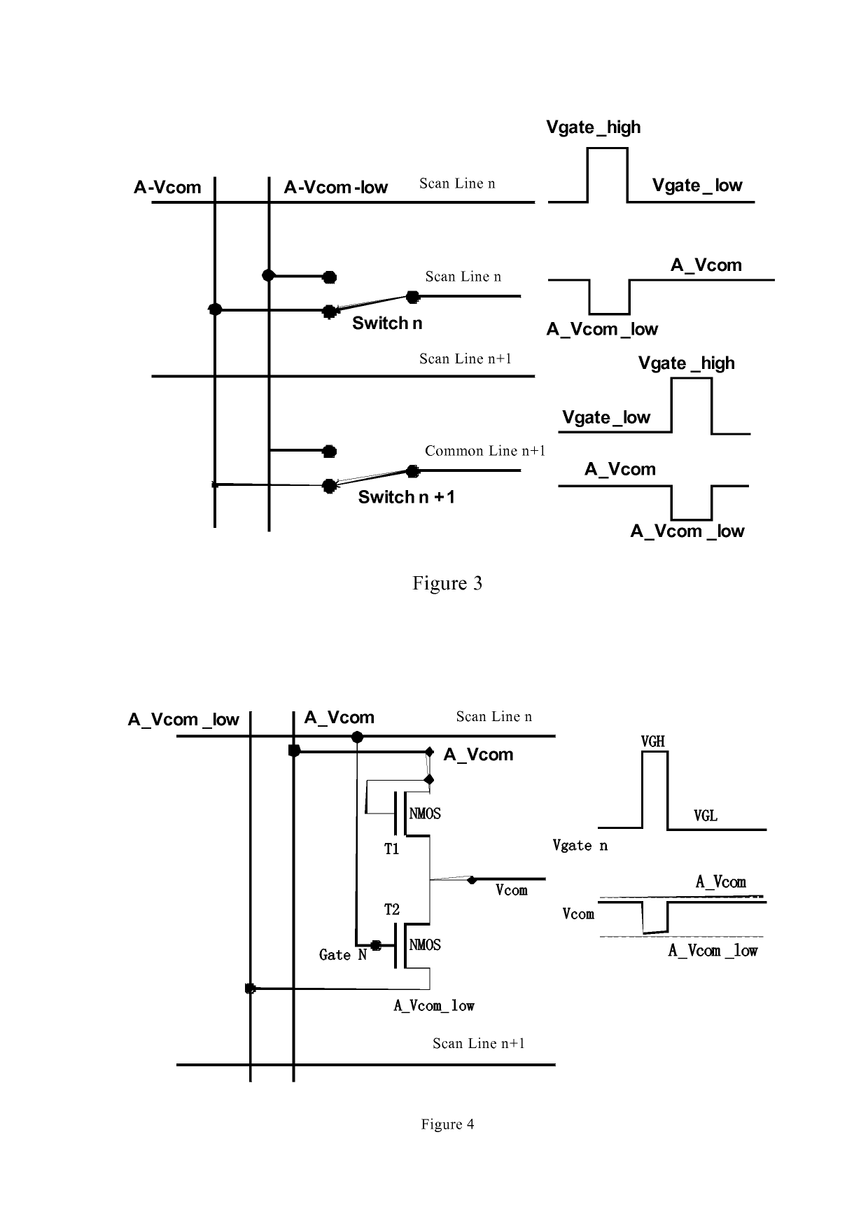

As shown in FIG. 3, a LCD device comprises a circuit for compensating feed-through voltage of a LCD device. The circuit for compensating feed-through voltage of a LCD device comprises a common line(s) and a storage capacitor(s). One end of the storage capacitor is connected to a drain electrode of a TFT corresponding to liquid crystal molecules, and the other end of the storage capacitor is connected to the common line. The common line is connected with a transfer switch. The transfer switch comprises two input ends; one input end is connected to a high-level reference voltage, and the other input end is connected to a low-level compensating voltage. The number of the common line(s) can be one or multiple. Preferably, the number of the common line(s) is multiple. Each common line is connected with a group of the storage capacitor, and each common line corresponds to a transfer switch. Thus, the parameters of the pixels in different positions are different. Each common line controls a group of display pixels. Different compensating voltages are set according to the parameter difference, thus the control accuracy is increased, and the display quality is further improved.

### Example 1

As shown in FIG. 4, the transfer switch comprises a first TFT T1 and a second TFT T2. A source electrode and a gate electrode of the first TFT T1 are connected to the reference voltage A-Vcom; a source electrode of the second TFT T2 is connected to the compensating voltage A-Vcom-low, and a gate electrode of the second TFT T2 is connected to a corresponding scan line of the LCD device; both the drain electrodes of the two TFTs are connected to the same common line Vcom.

Preferably, both the first TFT T1 and the second TFT T2 are N-type MOS transistors. Optionally, both the two TFTs are P-type MOS transistors. Alternately, one TFT is an N-type MOS transistor, and the other TFT is a P-type MOS transistor.

Because conventional LCD panels generally employ TFTs to control the pixel display, TFTs are used as transfer switches. The transfer switches can be simultaneously formed in the process of manufacturing the TFTs, favoring reduction of manufacturing cost.

### Example 2

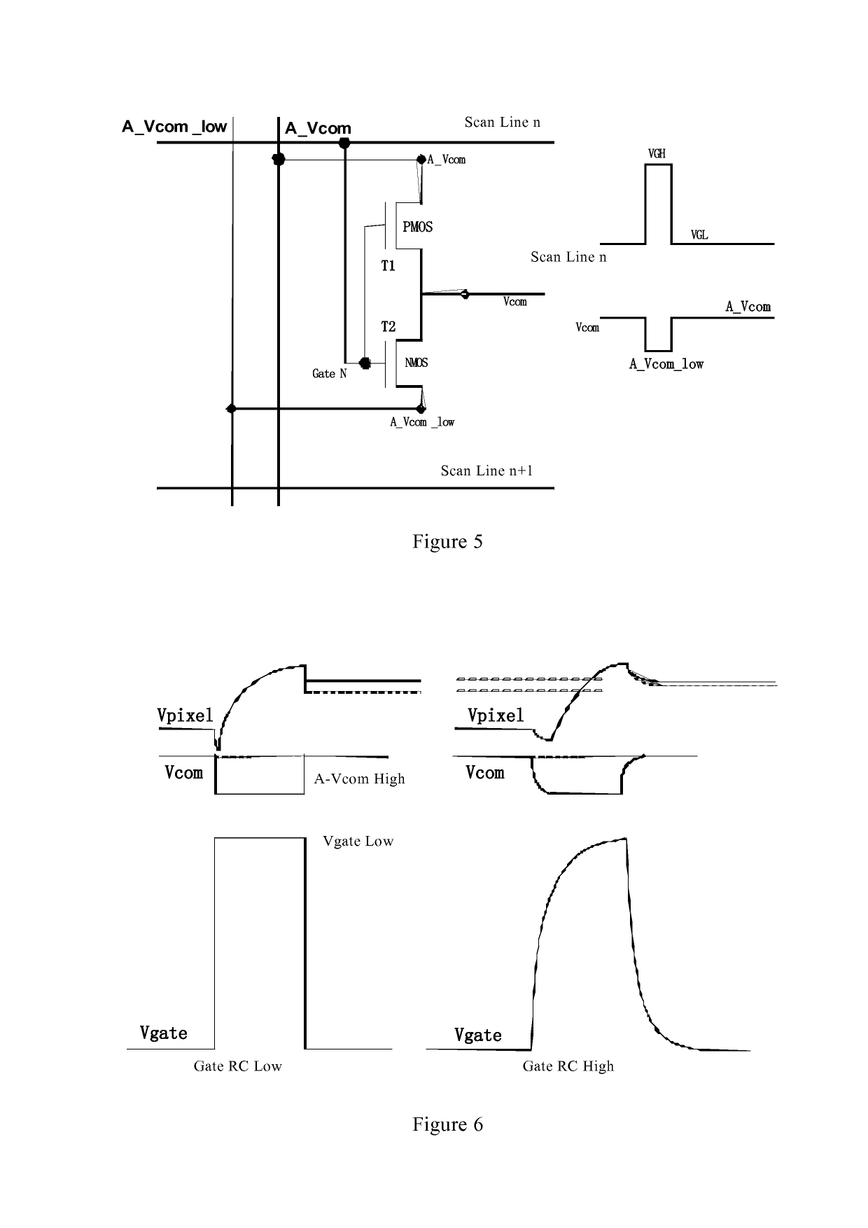

As shown in FIG. 5, the transfer switch comprises a first TFT T1 and a second TFT T2. A source electrode of the first TFT T1 is connected to the reference voltage A-Vcom, a source electrode of the second TFT T2 is connected to the compensating voltage A-Vcom-low, and both the drain electrodes of the two TFTs are connected to the same common line Vcom. The gate electrodes of the first TFT T1 and the second TFT T2 are connected to the same corresponding scan line of the LCD device. This is another specific control mode.

Preferably, the first TFT T1 is a P-type MOS transistor, and the second TFT T2 is an N-type MOS transistor. Optionally, both the two TFTs are P-type MOS transistors or N-type MOS transistors. Alternately, the first TFT T1 is an N-type MOS transistor, and the second TFT T2 is a P-type MOS transistor.

Because conventional LCD panels generally employ TFTs to control the pixel display, TFTs are used as transfer switches. The transfer switches can be simultaneously formed in the process of manufacturing the TFTs, favoring reduction of manufacturing cost.

As shown in FIG. 6, the circuit for compensating feed-through voltage of a LCD device compensates a feed-through voltage of the corresponding scan line by changing the voltage of the common line. Specifically, the drive process is summarized below: when the current scan line is being driven and the voltage Vgate of the scan line is at high level, the corresponding common line is switched to the low-level compensating voltage by the transfer switch, and the common line is switched to the high-level reference voltage when the drive of the scan line is removed and the voltage Vgate of the scan line is at low level. The feed-through voltage is corrected by adjusting the wave shape Vcom of the common line. If the number of the common line(s) is multiple, different compensating voltages are set according to different RC effects (Gate RC) of the scan lines in different positions. The lower the Gate RC is, the more the feed-through voltage corrected is. Vice versa, the higher the Gate RC is, the less the feed-through voltage corrected is. After compensation, the wave shapes of the voltages (Vpixel) at both ends of the pixels corresponding to different positions of the same scan line basically maintain the same.

The invention is described in detail in accordance with the above contents with the specific preferred examples. However, this invention is not limited to the specific examples. For the ordinary technical personnel of the technical field of the present invention, on the premise of keeping the conception of the present invention, the technical personnel can also make simple deductions or replacements, and all of which should be considered to belong to the protection scope of the present invention.

We claim:

1. A circuit for compensating feed-through voltage of a LCD device, comprising: a common line(s) and a storage capacitor(s); wherein one end of said storage capacitor is connected to a drain electrode of a TFT corresponding to liquid crystal molecules, the other end of said storage capacitor is connected to said common line, and said common line is connected with a transfer switch; said transfer switch comprises two input ends; one input end of said transfer switch is connected to a high-level reference voltage, and the other input end of said transfer switch is connected to a low-level compensating voltage.

2. The circuit for compensating feed-through voltage of a LCD device of claim 1, wherein the number of said common line(s) is at least two; each common line is connected with a group of said storage capacitor, and each common line corresponds to a transfer switch.

3. The circuit for compensating feed-through voltage of a LCD device of claim 1, wherein said transfer switch comprises a first TFT and a second TFT; a source electrode of said first TFT is connected to said high-level reference voltage, and a source electrode of said second TFT is connected to said low-level compensating voltage; both drain electrodes of said two TFTs are connected to the same common line; a gate electrode of said first TFT is connected to said high-level reference voltage, and a gate electrode of said second TFT is connected to a corresponding scan line of said LCD device.

4. The circuit for compensating feed-through voltage of a LCD device of claim 3, wherein both said first TFT and said second TFT are N-type MOS transistors.

5. The circuit for compensating feed-through voltage of a LCD device of claim 1, wherein said transfer switch comprises a first TFT and a second TFT; a source electrode of said first TFT is connected to said high-level reference voltage, and a source electrode of said second TFT is connected to said low-level compensating voltage; both drain electrodes of said two TFTs are connected to the same common line, and gate electrodes of said first TFT and said second TFT are connected to the same corresponding scan line of said LCD device.

6. The circuit for compensating feed-through voltage of a LCD device of claim 5, wherein said first TFT is a P-type MOS transistor, and said second TFT is an N-type MOS transistor.

7. The circuit for compensating feed-through voltage of a LCD device of claim 1, wherein the number of said common line(s) is at least two; each common line is connected with a group of said storage capacitor, and each common line corresponds to a transfer switch; said transfer switch comprises a first TFT and a second TFT; a source electrode of said first TFT is connected to said high-level reference voltage, and a gate electrode of said first TFT is connected to said high-level reference voltage; a source electrode of said second TFT is connected to said low-level compensating voltage, and a gate electrode of said second TFT is connected to the corresponding scan line of said LCD device; both drain electrodes of said two TFTs are connected to the same common line, and both said first TFT and said second TFT are N-type MOS transistors.

8. The circuit for compensating feed-through voltage of a LCD device of claim 1, wherein the number of said common line(s) is at least two; each common line is connected with a group of said storage capacitor, and each common line corresponds to a transfer switch; said transfer switch comprises a first TFT and a second TFT; a source electrode of said first TFT is connected to said high-level reference voltage; a source electrode of said second TFT is connected to said low-level compensating voltage, both gate electrodes of said first TFT and said second TFT are connected to the same corresponding scan line of said LCD device, and both drain electrodes of said two TFTs are connected to the same common line; said first TFT is a P-type MOS transistor, and said second TFT is an N-type MOS transistor.

9. A LCD device, comprising: a circuit for compensating feed-through voltage of a LCD device; wherein said circuit for compensating feed-through voltage comprises a common line(s) and a storage capacitor(s); one end of said storage capacitor is connected to a drain electrode of a TFT corresponding to liquid crystal molecules, the other end of said storage capacitor is connected to said common line, and said common line is connected with a transfer switch; said transfer switch comprises two input ends; one input end of said transfer switch is connected to said high-level reference voltage, and the other input end of said transfer switch is connected to said low-level compensating voltage.

10. The LCD device of claim 9, wherein the number of said common line(s) is at least two; each common line is connected with a group of said storage capacitor, and each common line corresponds to a transfer switch.

11. The LCD device of claim 9, wherein said transfer switch comprises a first TFT and a second TFT; a source electrode of said first TFT is connected to said high-level reference voltage, and a source electrode of said second TFT is connected to said low-level compensating voltage; both drain electrodes of said two TFTs are connected to the same common line; a gate electrode of said first TFT is connected to said high-level reference voltage, and a gate electrode of said second TFT is connected to a corresponding scan line of said LCD device.

12. The LCD device of claim 11, wherein both said first TFT and said second TFT are N-type MOS transistors.

13. The LCD device of claim 9, wherein said transfer switch comprises a first TFT and a second TFT; a source electrode of said first TFT is connected to said high-level reference voltage, and a source electrode of said second TFT is connected to said low-level compensating voltage; both drain electrodes of said two TFTs are connected to the same common line; gate electrodes of said first TFT and said second TFT are connected to the same corresponding scan line of said LCD device.

14. The LCD device of claim 13, wherein said first TFT is a P-type MOS transistor, and said second TFT is an N-type MOS transistor.

15. The LCD device of claim 9, wherein the number of said common line(s) is at least two; each common line is connected with a group of said storage capacitor, and each common line corresponds to a transfer switch; said transfer switch comprises a first TFT and a second TFT; a source electrode of said first TFT is connected to said high-level reference voltage, and a gate electrode of said first TFT is connected to said high-level reference voltage; a source electrode of said second TFT is connected to said low-level compensating voltage, and a gate electrode of said second TFT is connected to a corresponding scan line of said LCD device; both drain electrodes of said two TFTs are connected to the same common line, and both said first TFT and said second TFT are N-type MOS transistors.

16. The LCD device of claim 9, wherein the number of said common line(s) is at least two; each common line is connected with a group of said storage capacitor, and each common line corresponds to a transfer switch; said transfer switch comprises a first TFT and a second TFT; a source electrode of said first TFT is connected to said high-level reference voltage; a source electrode of said second TFT is connected to said low-level compensating voltage, both gate electrodes of said first TFT and said second TFT are connected to the same corresponding scan line of said LCD device, and both drain electrodes of said two TFTs are connected to the same common line; said first TFT is a P-type MOS transistor, and said second TFT is an N-type MOS transistor.

17. A method for compensating feed-through voltage of a LCD device, comprising: switching a corresponding common line to a low-level compensating voltage by a transfer switch when a current scan line is being driven; and switching the common line to a high-level reference voltage when the drive of the scan line is removed.
